(19) United States
(12) Patent Application Publication
(10) Pub. No.: US 2017/0276053 A1
(43) Pub. Date: Sep. 28, 2017

(54) After-Treatment System

(71) Applicant: Caterpillar Inc., Peoria, IL (US)

(72) Inventors: Wade J. Robel, Dunlap, IL (US); Tom Paulson, Groveland, IL (US); Anthony C. Rodman, Peoria, IL (US); J. Josh Driscoll, Dunlap, IL (US); Bogdan Balea, Peoria, IL (US)

(73) Assignee: Caterpillar Inc., Peoria, IL (US)

(21) Appl. No.: 15/270,467

(22) Filed: Sep. 20, 2016

Related U.S. Application Data
(63) Continuation-in-part of application No. 15/080,841, filed on Mar. 25, 2016.

(51) Int. Cl. F01N 13/00; B01D 53/94; F01N 3/022; F01N 3/08; F01N 3/10; F01N 3/20

(52) U.S. Cl. CPC F01N 13/009; F01N 3/103; F01N 3/206; F01N 3/2066; F01N 3/0222; F01N 3/0842; B01D 53/9477; B01D 53/9481; F01N 2240/40; F01N 2340/00; F01N 2610/02; B01D 2255/91; B01D 2255/9155; B01D 2255/904; B01D 2255/808

(57) ABSTRACT

An after-treatment system includes, in series along an exhaust gas flow direction through the after-treatment system: a diesel oxidation catalyst (DOC) or a passive NOx adsorber (PNA), a diesel exhaust fluid (DEF) delivery device, a soot-reducing device and a selective catalytic reduction (SCR) catalyst, which may also include an additional PNA.

### CROSS-REFERENCE TO RELATED APPLICATIONS

This patent is a continuation-in-part of copending U.S. patent application Ser. No. 15/080,841, which was filed on Mar. 25, 2016, and is incorporated herein in its entirety by this reference.

### TECHNICAL FIELD

This disclosure relates generally to engine systems and, more particularly, to exhaust after-treatment systems and methods.

### BACKGROUND

One known method for abating certain diesel engine exhaust constituents is by use of an exhaust after-treatment system that utilizes Selective Catalytic Reduction (SCR) of nitrogen oxides. In a typical SCR system, urea or a urea-based water solution is mixed with exhaust gas. In some applications, a urea solution is injected directly into an exhaust passage through a specialized injector device. The injected urea solution, which is sometimes referred to as diesel exhaust fluid (DEF), mixes with exhaust gas and breaks down to provide ammonia (NH₃) in the exhaust stream. The ammonia then reacts with nitrogen oxides (NOₓ) in the exhaust at a catalyst to provide nitrogen gas (N₂) and water (H₂O).

In typical applications, especially for large engines, high efficiency diesel particulate filters (DPF) are used in conjunction with NOx reduction systems such as systems using SCR. Such systems are generally quite effective in filtering soot while also converting nitrous oxide emissions from diesel exhaust, but such systems are also relatively large in volume. For example, a typical combined DPF/SCR after-treatment system, which may also include AMOX and DOC catalysts, can be approximately 3-6 times engine displacement in volume, which makes it challenging to design and integrate into a vehicle or engine system and also increases overall machine weight and cost.

It has been proposed in the past to coat the SCR catalyst onto the DPF filter substrate to eliminate a separate substrate for the SCR catalyst and allow DEF injection upstream of the DPF, but the low temperature soot oxidation reaction and fast SCR reaction will compete for NO₂ during engine operation, which will generally result in high DPF balance points, i.e., a system balance at high soot loadings on the DPF, which is known to make the DPF prone to cracking or catastrophic failure, and requires DPF regeneration at a high temperature. High temperature regeneration often requires so-called active regeneration, which entails conducting the regeneration using a heat source or a high fuel concentration, both of which reduce fuel economy for the machine.

One example of a previously proposed after-treatment system can be seen in U.S. Pat. No. 8,413,432 to Mullins et al. (“Mullins”). Mullins describes a regeneration control system for a vehicle that includes a regeneration control module and a regeneration interrupt module. The regeneration control module selectively provides fuel to an oxidation catalyst for a regeneration event of a particulate filter that occurs during a predetermined melting period for frozen dosing agent. The regeneration interrupt module selectively interrupts the regeneration event and disables the provision of fuel to the oxidation catalyst before the regeneration event is complete when a temperature of a dosing agent injector that is located between the oxidation catalyst and the particulate filter is greater than a predetermined temperature. As can be appreciated, therefore, the system of Mullins requires active regeneration.

Another example of a previously-proposed after-treatment system can be seen in JP2015025435A, which describes an exhaust emission control device that includes an HC trap catalyst layer and a low-temperature NOx adsorption catalyst layer that are laminated and supported on a gasoline particulate filter. In this system, however, there is limited capacity to convert NOx and there is also a limited exhaust gas operating range for the catalyst.

### SUMMARY

The disclosure describes, in one aspect, an after-treatment system. The after-treatment system is suitable for use, for example, with a machine that includes an engine having an exhaust conduit, which is adapted to route a flow of exhaust gas from the engine during operation. The after-treatment system may be connected to the exhaust conduit and disposed to receive and treat the flow of exhaust gas from the engine. The after-treatment system includes a diesel oxidation catalyst (DOC) connected to the exhaust conduit and arranged to receive the flow of exhaust gas from the engine, a transfer conduit connected in a downstream end of the DOC, a diesel exhaust fluid (DEF) delivery device associated with the transfer conduit and adapted to selectively inject DEF into the transfer conduit to be carried in a downstream direction by gas passing through the transfer conduit during operation, a soot-reducing device connected to a downstream end of the transfer conduit, the soot-reducing device arranged to receive the gas passing through the transfer conduit during operation, and a selective catalytic reduction (SCR) catalyst connected to a downstream end of the DPF opposite the transfer conduit, the SCR catalyst arranged to receive the gas passing through the soot-reducing device during operation.

In another aspect, the disclosure describes an after-treatment system for use in a machine having an engine, the engine having an exhaust conduit, the exhaust conduit adapted to route a flow of exhaust gas from the engine during operation, the after-treatment system being adapted for connection to the exhaust conduit and disposed to receive and treat the flow of exhaust gas from the engine. The after-treatment system includes a first passive NOx adsorber (PNA), the first PNA containing precious metals and being connected to the exhaust conduit and arranged to receive the flow of exhaust gas from the engine, and a transfer conduit connected in a downstream end of the first PNA. The after-treatment system further includes a diesel exhaust fluid (DEF) delivery device associated with the transfer conduit and adapted to selectively inject DEF into the transfer conduit to be carried in a downstream direction by gas passing through the transfer conduit during operation, a soot-reducing device connected to a downstream end of the transfer conduit, the soot-reducing device arranged to receive the gas passing through the transfer conduit during operation, the soot-reducing device being formed by a substrate, and a selective catalytic reduction (SCR) catalyst connected to a downstream end of the soot-removing device opposite the transfer conduit, the SCR catalyst arranged to receive the gas passing through the soot-reducing device during operation, the SCR catalyst carried on the substrate. The after-treatment system also includes a second PNA carried on the substrate, the second PNA being a non-precious metal adsorber.

### BRIEF DESCRIPTION OF THE DRAWINGS

FIG. 1 is a block diagram of an engine having a known SCR system, and

FIG. 2 is a partially sectioned outline view of a known exhaust treatment module.

FIG. 3 is a block diagram of an after-treatment system in accordance with the disclosure.

FIGS. 4A and 4B are schematic configurations of a known system packaging envelope,

FIGS. 5A and 5B are schematic configurations of a first embodiment of an after-treatment system in accordance with the disclosure and relative to the known packaging envelope, and

FIGS. 6A and 6B are schematic configurations of a second embodiment of an after-treatment system in accordance with the disclosure and relative to the known packaging envelope.

FIG. 7 is a graph showing operation of an after-treatment system over time in accordance with the disclosure.

FIG. 8 is a graph showing normalized NOx storage with respect to temperature in accordance with the disclosure.

### DETAILED DESCRIPTION

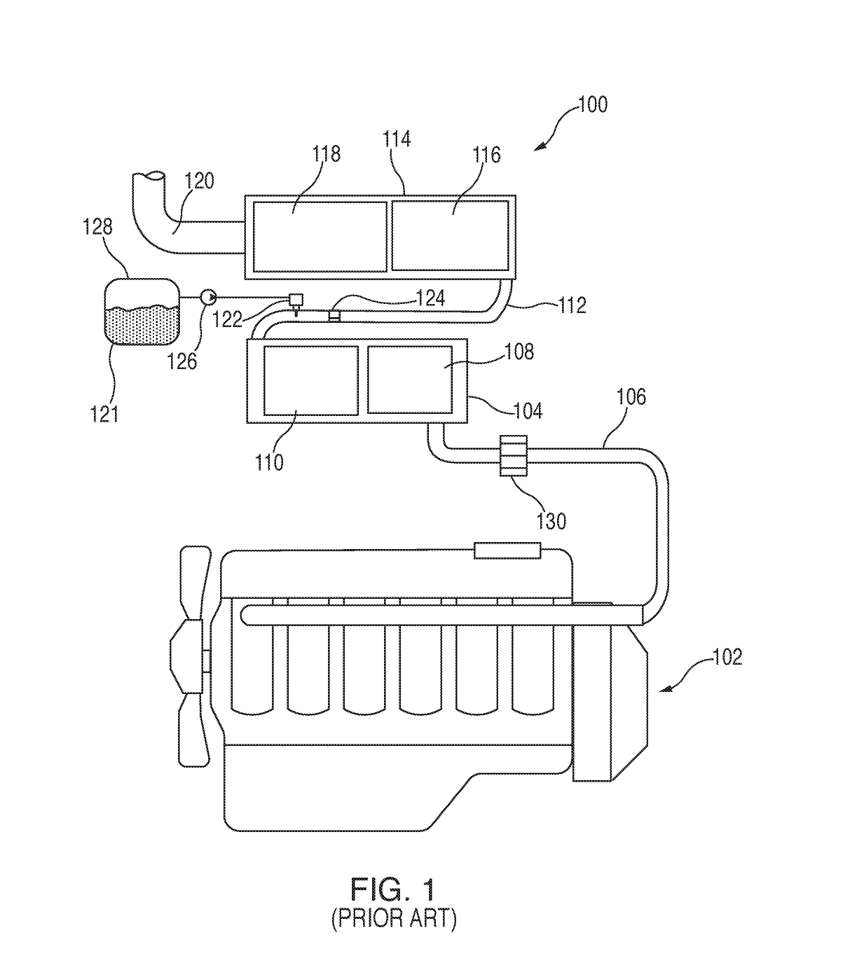

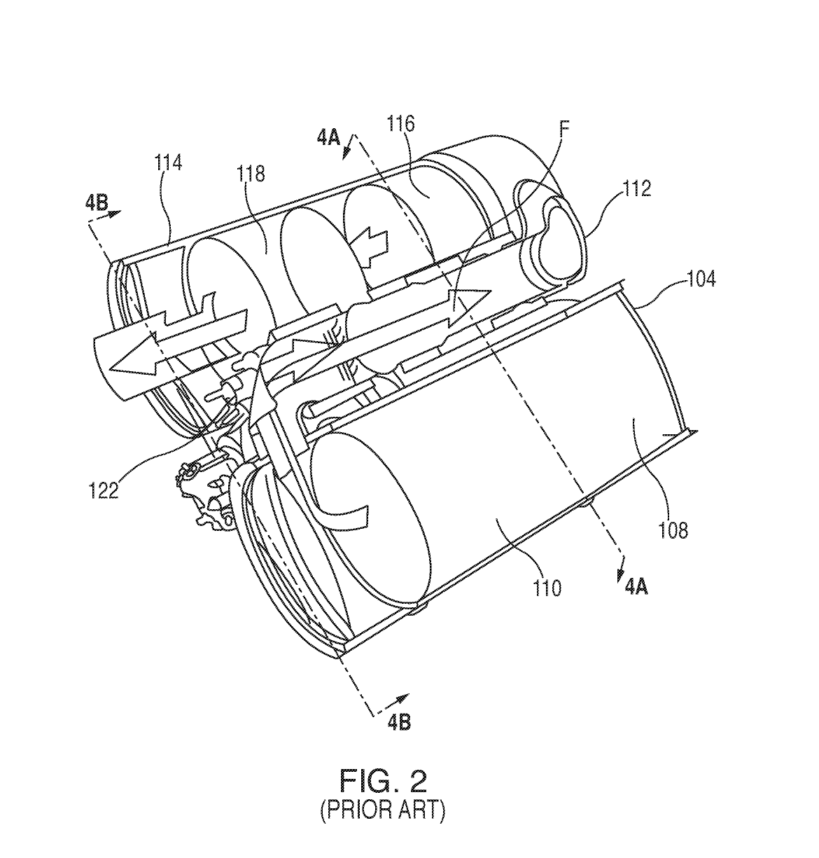

FIGS. 1 and 2 are representations of an exhaust after-treatment system 100, which is known in the art. In the illustrated embodiment, the system 100 includes a first module 104 that is fluidly connected to an exhaust conduit 106 of the engine 102. During engine operation, the first module 104 is arranged to internally receive engine exhaust gas from the conduit 106. The first module 104 contains a diesel oxidation catalyst (DOC) 108 arranged in series, upstream from a diesel particulate filter (DPF) 110, each of which has a relatively large frame. It is noted that the CDPF 110 is a coated DPF (CDPF). Exhaust gas provided to the first module 104 by the engine 102 first passes through the DOC 108 and then through the CDPF 110 before entering a transfer conduit 112.

The transfer conduit 112 fluidly interconnects the first module 104 with a second module 114 such that exhaust gas from the engine 102 may pass through the first and second modules 104 and 114 in series before being released at a stack 120 that is connected to the second module. In the illustrated embodiment, the second module 114 encloses a SCR catalyst 116 and an Ammonia Oxidation Catalyst (AMOX) 118, each formed on its own respective substrate. The SCR catalyst 116 and AMOX 118 operate to treat exhaust gas from the engine 102 in the presence of ammonia, which is provided after degradation of DEF injected into the exhaust gas in the transfer conduit 112. A regeneration device 130 is disposed upstream of the first module 104 along the conduit 106. The regeneration device 130, which can be implemented as a fuel-fired heater, increases exhaust gas temperature for an active regeneration of the CDPF 110, selectively during operation as is known.

The DEF 121 is injected into the transfer conduit 112 by a DEF injector 122. The DEF 121 is contained within a reservoir 128 and is provided to the DEF injector 122 by a pump 126. As the DEF 121 is injected into the transfer conduit 112, it mixes with exhaust gas passing therethrough and is thus carried to the second module 114. To promote mixing of DEF with exhaust, a mixer 124 may be disposed along the transfer conduit 112. FIG. 2 is a partially sectioned outline view of the system 100, where same or similar structures as corresponding structures previously described are denoted by the same reference numerals previously used for simplicity. As shown in FIG. 2, the first and second modules 104 and 114 are disposed next to one another, with the transfer conduit 112 disposed between them. The DEF injector 122 is disposed on an upstream end of the transfer conduit 112 relative to a direction of exhaust gas flow, F.

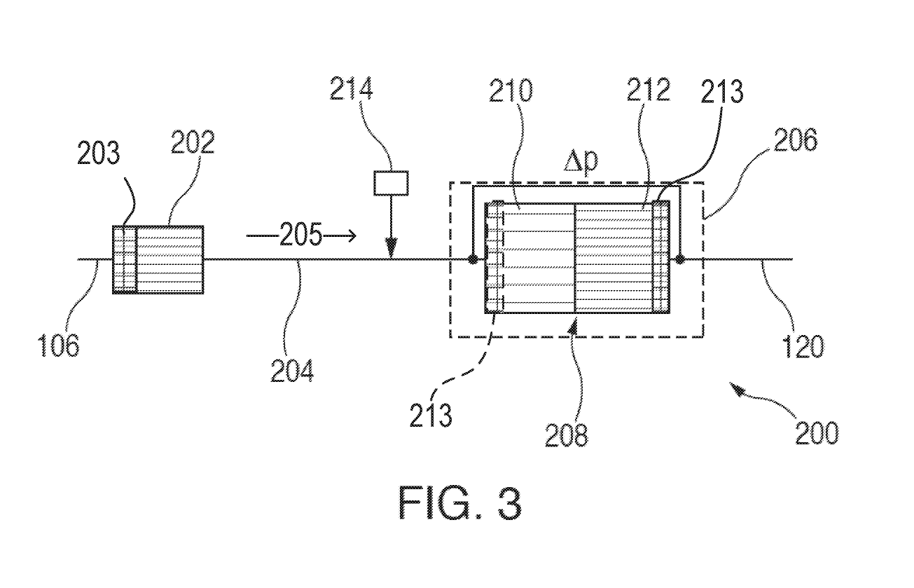

FIG. 3 is a block diagram of an after-treatment system 200 in accordance with the disclosure. The system 200 is configured to replace the system 100 for the engine 102 (FIG. 1) but without necessarily use of the regeneration device 130 and with a smaller package size, as will be described hereinafter. The system 200 includes a DOC 202, which in this embodiment has a smaller diameter and an overall smaller volume than the DOC 108 (FIG. 1). The DOC 202 may optionally further include a relatively small NOx absorber to improve flow temperature of exhaust gas temperature flowing there through. More specifically, in one embodiment, the DOC 202 may further include an optional precious metal loaded passive NOx adsorber. In the illustrated embodiment, the DOC 202 is omitted in favor of the PNA 203. Examples of precious metal adsorbers include but are not limited to washcoats applied to the DOC substrate that comprise one or more precious metals such as platinum, palladium, rhodium, and others.

In the illustrated embodiment, the DOC 202 includes a passive NOx adsorber (PNA) 203, which can be applied as a washcoat, at an inlet end thereof, as shown in FIG. 3. Exhaust gas flow from the engine passes from the left of the figure towards the right, as indicated by arrow 205. It should be appreciated that the PNA 203 may be disposed anywhere along the area occupied by the DOC 202. During operation, the DOC 202 converts NOx to NO2, which is used downstream by other components. With the addition of the PNA 203, an even larger portion of NOx is converted to NO2 as it passes through the remaining components in the system 200. The addition of the PNA 203 can also improve cold-start operation of the system by retaining NOx until the system has sufficiently warmed up.

The system 200 is arranged such that the exhaust conduit 106 from the engine 102 (FIG. 1) provides exhaust gas from the engine 102 to the DOC 202, or to the PNA 203, each of which operates in the known fashion. A transfer conduit 204 fluidly interconnects the DOC 202 or PNA 203 to a treatment module 206, which is connected to the stack 120 (also see FIG. 1) either directly or through a muffler (not shown). The treatment module 206 includes a series-compact device 208, which in the illustrated embodiment includes a DPF 210, and a combined SCR plus AMOx (SCR/AMOx) 212. In the embodiment shown, the after-treatment 200 further includes a non-precious metal PNA 213. In one embodiment, the PNA 213 is disposed downstream of the first PNA 203 or DOC 202 and can be created by depositing a washcoat over the substrate of the DPF 210, which is denoted in FIG. 3 in dashed lines, or on the SCR/AMOx 212, which is denoted in FIG. 3 with solid lines.

A DEF injector 214 is disposed along the transfer conduit 204 and arranged to inject DEF therein between the DOC 202 and the series-compact device 208 during operation such that injection of DEF occurs downstream of the DOC 202 and upstream of the series-compact device 208, which includes the PNA 213.

For achieving desired emissions, the DPF 210 in the illustrated embodiment is a monolithic, wall-flow type substrate that can be made from advanced cordierite (AC) or aluminum titanate (AT) having an asymmetric channel (ACT) construction with larger inlet and smaller outlet channels. The DPF 210 shown has about 300 channels per square inch (cpsi) and is uncoated, uncatalyzed or includes a hydrolysis coating. During operation, the DOC 202 creates NO₂ from NO and O₂ present in the exhaust stream. The NO₂ created by the DOC 202 is carried to the DPF 210 to support a passive regeneration of the DPF 210 at a relatively low temperature of about 200 def. C. In the embodiment of the system 200 that includes the optional PNA 203, the PNA 203 allows for additional NO2 generation by reducing the NO2 concentration in the exhaust gas stream passing therethrough. When the PNA 203 reaches its release temperature, it will release stored NO2 which is useful in the operation of the downstream components. For example, the released NO2 may be used by the DPF in the system to react and oxidize soot and produce NO and CO2. Further, the NO2 can be converted by an SCR catalyst in the system, and/or be recaptured by an additional PNA disposed downstream of the DEF injector such as the PNA 213, and then be re-released or converted.

The SCR/AMOx 212 of the system 200 in the illustrated embodiment is built on a substrate having about 600 cpsi that is physically connected to the substrate of the DPF 210 or is otherwise in close proximity thereto within the treatment module 206 to act as a single substrate. In the illustrated embodiment, the system 200 operates to remove more than 98% of engine soot on a mass or particulate count basis, and reduces NOx by more than 96% on a mass basis.

In general, the after-treatment system 200 may include additional or alternative structures for treating the exhaust gas stream provided from the engine 102. For example, in an alternative embodiment, a soot-reducing, soot-filtering or soot-removing device such as an electrostatic precipitator, a plasma burner or any other known soot-removing device may be used instead of, or in addition to, the DPF 210 in the after-treatment system 200. The term soot-reducing device, as used herein, is contemplated to include any structure that operates to at least partially remove soot and/or other particulates from an exhaust stream of an engine as the exhaust stream passes through, over or around the soot-reducing device. Moreover, in an alternative embodiment, the after-treatment system 200 may be configured and/or sized to remove an optimized fraction of soot, for example, between 10% and 90% on a mass or particulate count basis, and to reduce NOx by an optimized fraction, for example, more than 70% on a mass basis, from the flow of exhaust from the engine.

### INDUSTRIAL APPLICABILITY

This disclosure relates to after-treatment systems for diesel engines used alone or in conjunction with other power sources and types in a machine. More particularly, the disclosure describes use of an uncatalyzed or hydrolysis coated low backpressure DPF, which allows DEF dosing upstream of a single can with a series DPF and SCR catalyst. One challenge in designing and integrating a combined DPF/SCR system for an engine in a machine is the requirement for DEF injection to be downstream of the DOC or a catalyzed DPF to avoid ammonia oxidation to NOx. The described embodiments advantageously reduce package size and weight for the after-treatment devices as compared with known systems while maintaining passive soot oxidation capability, i.e., the ability to avoid using active DPF regeneration, which avoid the cost, complexity and fuel consumption increase associated with active regeneration. The described systems and methods, therefore, provide greater flexibility than known systems have to integrate low or high temperature thermal management. Additionally, the systems in accordance with the disclosure provide the capability of moving or relocating the DPF from in-series with the DOC, as is the case in known systems, to a remote location, for example, on the engine. This flexibility also allows the DOC aspect ratio to be optimized for packaging resulting in considerable height and width reductions of 15% or more as compared to previously known systems. Overall, the disclosed systems and methods provide a compact, high efficiency package that works with low or high temperature DPF regeneration.

The present disclosure is applicable to internal combustion engines operating in mobile or stationary applications. The disclosed systems are advantageously more compact the systems having comparable emission constituent abatement performance. The systems in accordance with the present disclosure are simpler and more cost effective to operate in that the DPF used is suitable for both passive and active regeneration, which makes use of an active regeneration device optional.

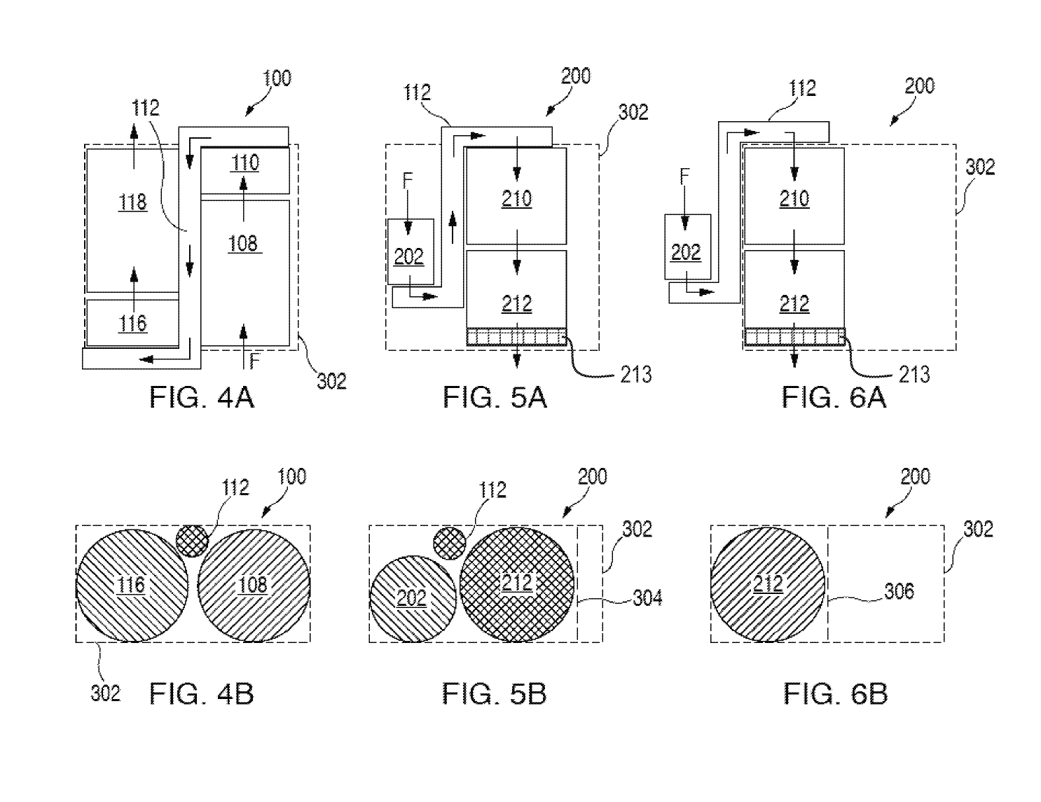

To illustrate the package size benefit of the system in accordance with the present disclosure, various qualitative representations are compared. In general, while the DPF 210 and SCR/AMOx 212 may have a diameter that is comparable to the SCR catalyst 116 and AMOX 118 (FIG. 1), the combined series-compact device 208 has an overall length that is quite shorter than the overall combined substrate length of all devices used in the system 100 (FIG. 1), which greatly reduces the overall package size of the various systems. This is discussed below relative to FIGS. 4A and 4B as compared to FIGS. 5A, 5B, 6A and 6B.

More specifically, FIG. 4A qualitatively shows a packaging envelope 302 for the components of the system 100 (FIG. 1), in block form, from a top perspective, and FIG. 4B shows the packaging envelope 302 from a front perspective. As can be seen from these figures, where arrows “F” denote the flow of exhaust gas through each system, a footprint of the packaging envelope 302 is defined by the space that is required to accommodate arrangement of the DOC 108 and CDPF 110 on the right side, and the SCR catalyst 116 and AMOx 118 on the left side of FIG. 4A in the orientation shown. A cross sectional area of the packaging envelope 302 is similarly defined by the diameters of the various substrates mentioned above, as well as by the diameter of the transfer conduit 112, as shown in FIG. 4B.

FIGS. 5A and 5B show the components of the system 200 in accordance with the disclosure arranged within the packaging envelope 302 of the system 100 for comparison and to illustrate the space-saving nature of the system 200 over the system 100. As shown, the arrangement of the smaller-diameter DOC 202, which may alternatively include the PNA 203, allows the centerline of the series-combined substrates for the DPF 210 and the SCR/AMOx 212, which also includes the PNA 213, to move closer to a centerline of the DOC 202, which results in an overall narrower combined width for these components and more space being available to route the transfer conduit 112. Therefore, and as can be seen from FIGS. 5A and 5B, the volume 304 required to contain or package the system 200 is about 15% less than the volume occupied by the packaging envelope 302, with additional space being available around the components to route other machine components, add shielding, and the like.

FIGS. 6A and 6B show the components of the system in accordance with an alternative embodiment of the disclosure, in which the DOC 202, which may also include the PNA 203, is mounted remotely from the remaining components of the system 200, for example, on the engine or anywhere along the exhaust conduit supplying exhaust gas from the engine to the system 200. In this embodiment, the DOC 202 and, optionally, the PNA 203, is placed outside from the packaging envelope 302 due to its remote mounting. The series-combined substrates for the DPF 210 and the SCR/AMOx 212, which also includes the PNA 213, are moved to one side of the envelope thus reducing the volume 306 required to contain or package the system 200 by about 50% or more relative to the volume occupied by the packaging envelope 302.

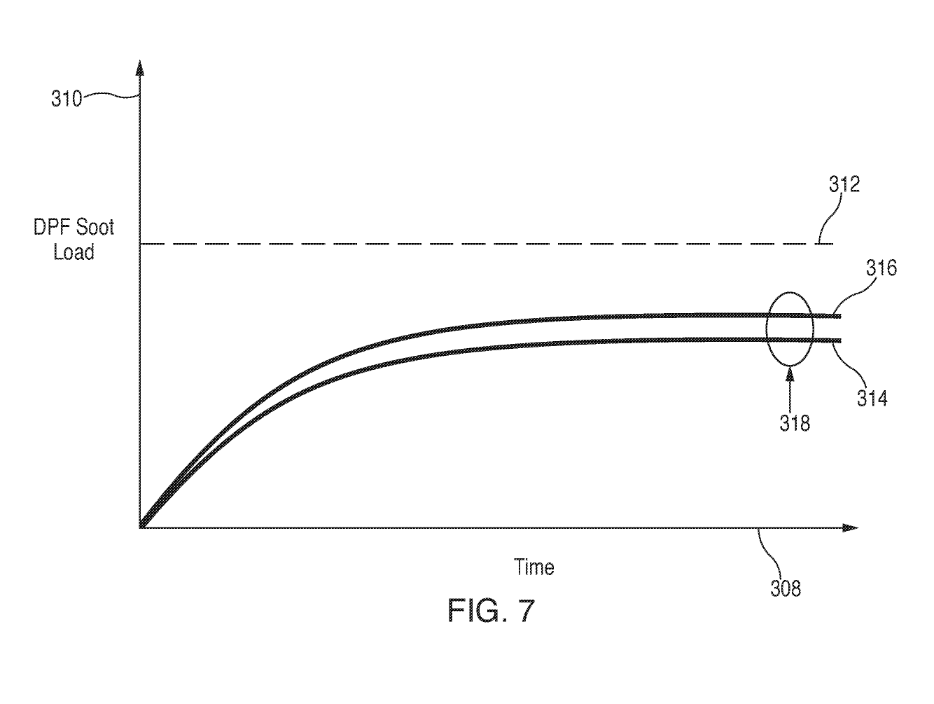

A qualitative graph showing the soot loading in the DPF of the system 200 as compared to the system 100 over time is shown in FIG. 7. In the graph, the horizontal axis 308 represents time, for example, in hours, and the vertical axis 310 represents soot loading, for example, as a percentage of a critical soot loading 312 at which the DPF plugging with soot particles is beyond a desired extent and may render the DPF essentially plugged. The graph shows two curves, a first curve 314 and a second curve 316. The first curve 314 represents a soot loading over time of the CDPF 110 (FIG. 1) of the system 100, which is considered as the baseline system. The second curve 316 represents a soot loading over time of the DPF 210 of the system 200 (FIG. 3) of the system 200 in accordance with the disclosure.

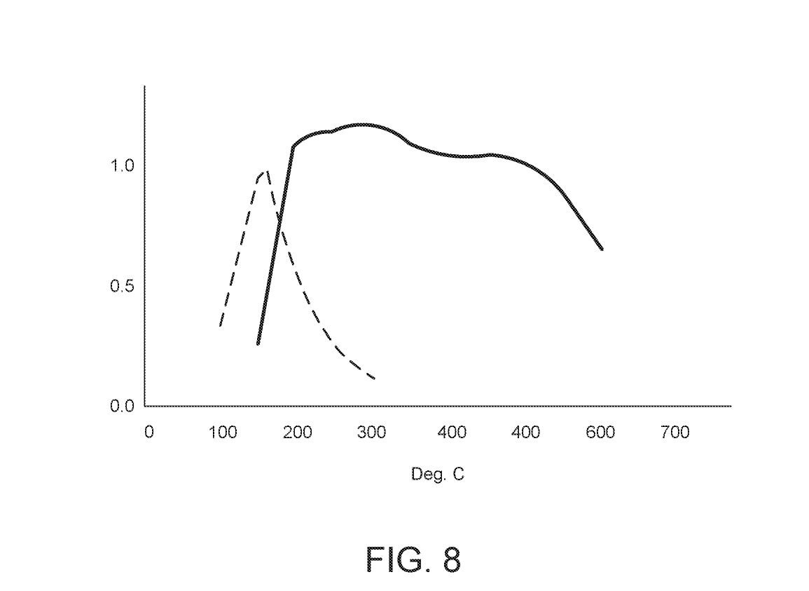

A qualitative graph showing a normalized storage of NOx in various components of an after-treatment system is shown in FIG. 8. In the graph, a normalized amount of NOx stored or abated in the system is measured along the vertical axis, and a temperature of the substrates that carry the various system components in deg. C. is measured along the horizontal axis. In reference to FIG. 8, the normalized amount of NOx that is stored in the PNA is shown using a dashed line, and the amount of NOx that is abated in the SCR is shown using a solid line. In reference to the graph, it can be see that for relatively low temperatures between 100 and 150 deg. C., NOX is primarily stored on the PNA. At or above a temperature of about 150 deg. C., the capacity of the PNA to store NOx begins to drop, but the ability of the SCR to abate NOx begins to rise until about a temperature of about 200 deg. C., above which temperature the SCR abates NOx provided by the engine. In this way, the PNA improves low temperature performance of the SCR, even for cold starting conditions of the engine. In reference to FIG. 8, the system 200 (FIG. 3) is advantageously

As can be seen from the graph, the soot loading in both DPFs increases initially before stabilizing and reaching a balance point over time because in both systems 100, 200 the DPF continuously regenerates during operation and reaches a steady-state soot loading. When comparing the curves 314 and 316, it can be seen that the loading in the DPF 210 in the system 200 settles at a soot loading that is higher than the corresponding soot loading in the CDPF 110 in the system 100. However, although the soot loading in the DPF 210 is higher than the loading in the CDPF 110, both are still below the critical soot loading 312. As a practical matter, the higher soot loading in the DPF 210, which may increase the pressure drop across the DPF, will not appreciably affect engine operation given the relatively higher cell density of the SCR/AMOx 212 used in the system 200 as compared to the system 100.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. An after-treatment system for use in a machine having an engine, the engine having an exhaust conduit, the exhaust conduit adapted to route a flow of exhaust gas from the engine during operation, the after-treatment system being adapted for connection to the exhaust conduit and disposed to receive and treat the flow of exhaust gas from the engine, the after-treatment system comprising:
a diesel oxidation catalyst (DOC) connected to the exhaust conduit and arranged to receive the flow of exhaust gas from the engine;
a transfer conduit connected in a downstream end of the DOC;
a diesel exhaust fluid (DEF) delivery device associated with the transfer conduit and adapted to selectively inject DEF into the transfer conduit to be carried in a downstream direction by gas passing through the transfer conduit during operation;
a soot-reducing device connected to a downstream end of the transfer conduit, the soot-reducing device arranged to receive the gas passing through the transfer conduit during operation, the soot-reducing device being formed by a first substrate;
a selective catalytic reduction (SCR) catalyst connected to a downstream end of the soot-removing device opposite the transfer conduit, the SCR catalyst arranged to receive the gas passing through the soot-reducing device during operation, the SCR catalyst carried on a second substrate; and
a passive NOx adsorber (PNA) carried on at least one of the first substrate and the second substrate.

2. The after-treatment system of claim 1, wherein the soot-reducing device is at least one of uncatalyzed, uncoated and includes a hydrolysis coating.

3. The after-treatment system of claim 1, wherein the first substrate and the second substrate are integrally formed as a single substrate.

4. The after-treatment system of claim 1, wherein the soot-reducing device is a diesel particulate filter (DPF) that is made from a monolithic, thin wall-flow type substrate.

5. The after-treatment system of claim 4, wherein the DPF is made from advanced cordierite (AC) or aluminum titanate (AT).

6. The after-treatment system of claim 5, wherein the DPF has an asymmetric channel (ACT) construction with larger inlet and smaller outlet channels.

7. The after-treatment system of claim 4, wherein the DPF has about 300 channels per square inch (cpsi).

8. The after-treatment system of claim 1, wherein the SCR catalyst further includes an ammonia oxidation catalyst (AMOx) formed as a coating on the substrate.

9. The after-treatment system of claim 1, wherein the PNA is formed as a coating on the substrate.

10. The after-treatment system of claim 9, wherein the PNA is disposed in a portion of the substrate that carries the SCR catalyst, the substrate having about 600 cpsi.

11. The after-treatment system of claim 10, wherein the substrate of the SCR catalyst is enclosed in a common housing with a substrate of the soot-reducing device and the PNA.

12. The after-treatment system of claim 1, wherein the after-treatment is configured to remove more than 98% of soot on a mass or particulate count basis, and to reduce NOx by more than 96% on a mass basis, from the flow of exhaust gas from the engine.

13. The after-treatment system of claim 1, wherein each of the DOC, the soot-reducing device and the SCR catalyst has a generally cylindrical shape having a respective outer diameter, and wherein a diameter of the DOC is smaller than a diameter of the soot-reducing device and a diameter of the SCR catalyst.

14. The after-treatment system of claim 13, wherein a diameter of the DOC is smaller than a diameter of the soot-reducing device.

15. The after-treatment system of claim 13, wherein the diameter of the soot-reducing device is equal to the diameter of the SCR catalyst.

16. The after-treatment system of claim 1, wherein the DOC further includes structures arranged to absorb NOx from the flow of exhaust gas from the engine.

17. The after-treatment system of claim 1, wherein a flow of gases through the after-treatment system is defined that begins at the engine, passes through the DOC, passes through the transfer conduit and past the DEF delivery device, passes through the soot-reducing device, and passes through the SCR catalyst.

18. The after-treatment system of claim 1, wherein the DOC is mounted closer to the engine than to the soot-reducing device.

19. The after-treatment system of claim 1, wherein the soot-reducing device is a diesel particulate filter (DPF) that is configured for passive regeneration at a temperature of about 200 deg. C.

20. An after-treatment system for use in a machine having an engine, the engine having an exhaust conduit, the exhaust conduit adapted to route a flow of exhaust gas from the engine during operation, the after-treatment system being adapted for connection to the exhaust conduit and disposed to receive and treat the flow of exhaust gas from the engine, the after-treatment system comprising:
a first passive NOx adsorber (PNA), the first PNA containing precious metals and being connected to the exhaust conduit and arranged to receive the flow of exhaust gas from the engine;
a transfer conduit connected in a downstream end of the first PNA;
a diesel exhaust fluid (DEF) delivery device associated with the transfer conduit and adapted to selectively inject DEF into the transfer conduit to be carried in a downstream direction by gas passing through the transfer conduit during operation;
a soot-reducing device connected to a downstream end of the transfer conduit, the soot-reducing device arranged to receive the gas passing through the transfer conduit during operation, the soot-reducing device being formed by a substrate;
a selective catalytic reduction (SCR) catalyst connected to a downstream end of the soot-removing device opposite the transfer conduit, the SCR catalyst arranged to receive the gas passing through the soot-reducing device during operation, the SCR catalyst carried on the substrate; and
a second PNA carried on the substrate, the second PNA being a non-precious metal adsorber.
